(19) United States
(12) Patent Application Publication
(10) Pub. No.: US 2025/0289915 A1
(43) Pub. Date: Sep. 18, 2025

(54) RESIN DERIVED FROM END-OF-LIFE TIRE

(71) Applicant: The Goodyear Tire & Rubber Company, Akron, OH (US)

(72) Inventors: Xiaoping Yang, Streetsboro, OH (US); Kuo-Chih Hua, Richfield, OH (US); Paul Harry Sandstrom, Cuyahoga Falls, OH (US); Manuela Pompei, Reuler (LU); Joseph John Kulig, Tallmadge, OH (US); Teresa Diane Martter, Akron, OH (US)

(21) Appl. No.: 18/605,257

(22) Filed: Mar. 14, 2024

(51) Int. Cl. C08F 10/14; B60C 1/00; C09J 123/24

(52) U.S. Cl. CPC C08F 10/14; B60C 1/0016; B60C 1/0041; C09J 123/24

(57) ABSTRACT

A hydrocarbon resin comprises a reaction product of the polymerization reaction of end of life tires (ELT) oil monomers and having a Tg ranging from about −30° C. to about 140° C., a softening point from about 10° C. to about 170° C. and a molecular weight Mw between 100 and 5000 Da.

### BACKGROUND OF THE INVENTION

It is possible to thermally decompose used tires (“end of life” tires or “ELTs”) to isolate organic and inorganic materials therefrom. The products obtained from thermally decompose tires can include carbon black, steel, sulfur (isolated in the form of sulfur-containing compounds), gas(es), and/or a liquid oily product.

U.S. Pat. No. 7,628,892 to PRTI Inc. discloses a process for producing a two-phase fluid mixture from phase depolymerization of rubber products, like worn tires. The '892 process involves depolymerization and separation of a mostly gaseous phase having physiochemical characteristics capable of feeding an ordinary diesel engine. Liquid phase hydrocarbons are also collected using the '892 process (hereafter “ELT-oil”).

Typical tire recycling technologies produce lower quality materials that have limited use to enter production of new tires. It is now discovered that the depolymerization process can be optimized to maximize suitable organic hydrocarbon molecules, like, C5, C9, limonene and other resin precursors, such as monomers of the styrene type, in the liquid ELT oil phase.

It is desirable to use the liquid ELT-oil's hydrocarbons to produce hydrocarbon resins. The present disclosure provides resin(s), and a process for polymerizing the same, using ELT oil collected from depolymerization of tire/rubber products.

### SUMMARY OF THE INVENTION

One embodiment of the disclosure is directed to a hydrocarbon resin comprising a reaction product of the polymerization reaction of ELT oil monomers. The reaction product is characterized by a glass transition temperature, Tg, ranging from about −30° C. to about 140° C., a softening point from about 10° C. to about 170° C., and a molecular weight Mw between 100 and 5000 Da.

Another embodiment of the disclosure is directed to a tire having a tread and/or carcass compound comprising at least one rubber selected from the group consisting natural rubbers, rubbers derived from a diene monomer, and mixtures thereof, and an ELT hydrocarbon-based resin.

Another embodiment of the disclosure is directed to a method of forming a resin from ELT oil. The method comprises the steps of obtaining an ELT oil derived from thermal depolymerization of ELTS and polymerizing the ELT oil to produce an ELT hydrocarbon-based resin.

### Brief Description of the Drawings

### DETAILED DESCRIPTION OF THE INVENTION

The present invention relates to new synthetic resins and to a method for their preparation. It is a further object of this invention to provide new and useful copolymers prepared from the hydrocarbons formed from ELT depolymerization and to provide a method for their preparation.

In one embodiment, the ELT oil is produced using the operation described in U.S. Pat. No. 7,628,892 titled “SYSTEM AND PROCESS FOR THE PRODUCTION OF COMBUSTABLE SUBSTANCES BY DEPOLYMERIZATION OF RUBBER PRODUCTS”, which is incorporated by reference in its entirety. The 892' patent discloses a process and a plant for producing liquid and storable combustible substances by depolymerization of ELTs. Whole tires or pieces of the same can be used. The '892 process produces a carbonaceous fuel product and a gaseous product by (S1) introducing calcium oxide to the tires in a depolymerizing device; (S2) activating combustion of the tires; (S3) carrying out a thermal process to form a bi-phases mixture comprising combustible micro-particles (i.e., oily particles in the form of drops) derived from the depolymerization; (S4) physically separating the solid phase from the liquid phase using condensation; (S5) and burning the gaseous phase while containing the liquid as a combustible substance.

The amount of combustible liquid products will vary; however, the total liquid product content (i.e., the “oil content” in the tire rubber) using the '892 process ranges between 35% to 40% of the weight of the tires and has the physiochemical characteristics shown in Table 1 of the '892 patent.

Hydrocarbon products with five or more carbons in their chains are liquid at room temperature. In one embodiment, a liquid hydrocarbon product is produced using the operation described in U.S. Pat. No. 10,703,876 to PRTI and titled “APPARATUS AND METHOD FOR THERMALLY DEMANUFACTURING TIRES AND OTHER WASTE PRODUCTS”, which is incorporated by reference in its entirety. The '876 patent discloses a process and a plant for producing liquid and storable combustible substances by depolymerization of ELTs. Whole tires or pieces of the same can be used. The '876 process produces a carbonaceous fuel product and a gaseous product by (S1) introducing oxygen or air through a register over which material (e.g., tires) to be depolymerized overlies; (S2) partially combusting, or smoldering, the material while allowing a burner to generate heat using the air; (S3) separating the liquid hydrocarbon products from the gaseous products using a condenser, which lowers the temperature of the gas stream to obtain a liquid stream and a gas stream; and (S4) collecting the cooled liquid products.

There is no limitation made herein to the type of (e.g., pyrolysis, ELT) oil supplied to the presently disclosed resin synthesis. The preferred embodiment contemplates ELT oil produced using thermal decomposition, thermal de-manufacturing and/or thermal depolymerization of cured and/or uncured rubber articles and waste using processes similar to those described supra. Thermal depolymerization is distinguishable from traditional pyrolysis because it employs an oxidizing agent—i.e., air—to continue combustion of tires. Such oxidizing agent is absent in pyrolysis, such as the one described in US 20230407184 to Michelin in which a temperature ramp separates a pyrolysis oil from gaseous (below 150° C.) and solid (above 260°) effluents. In '184, the pyrolysis oil is an intermediate fraction supplied to resin synthesis.

In thermal depolymerization, however, a condensation phenomenon takes place and directs formed liquid effluent to a container. Such liquid effluent (i.e., the liquid phase hydrocarbon) is defined herein as the “base ELT oil” formed from ELT monomers. The base ELT oil can be either used as is or undergo one or more distillations to generate a refined ELT oil. As used herein, “refined ELT oil” can comprise distilled ELT oil or oil purified by other means known to one of ordinary skill in the art. The “distilled ELT oil” is “refined ELT oil”, but refined ELT oil may or may not comprise distilled ELT oil.

As used herein, “ELT oil”, “oil”, “liquid effluent”, “liquid phase” or hydrocarbons are interchangeable and used synonymously hereafter. As explained supra, “base ELT oil” refers specifically to the oil produced using thermal depolymerization of rubber articles. Although not limiting, these articles are contemplated to include whole or partial tires (new or end-of-life) and production plant waste. In one embodiment, it excludes the oil produced by pyrolysis. “ELT oil” on the other hand can refer to oil produced using pyrolysis or thermal depolymerization, among other approaches.

The operating conditions of the process according to the '876 patent give a base ELT oil comprising at least 15 wt. % of C₄-C₁₂ olefinic monomers, preferably at least 20 wt. % of C₄-C₁₂ olefinic monomers.

“Olefinic monomers” means hydrocarbon-containing compounds that comprise unsaturated carbon-carbon bonds and are polymerizable in suitable conditions. Among these olefinic monomers, examples include limonene, terpenes, aromatic olefins such as styrene, alpha-methylstyrene, indene, coumarone, linear or cyclic olefins such as dicyclopentadiene.

Further refinement of the base ELT oil can be carried out by any method known by a person skilled in the art. It is discovered that overall olefin content, as defined supra, of the ELT oil does not change much between the base ELT oil and a refined ELT oil. However, it is discovered that the limonene content of a distilled ELT oil gets richer after each distillation cycle. It is also further believed that the limonene content can be maximized through use of ELTs having a high-content of polyisoprene elastomers, such as natural rubber, as the feedstock, and by optimization of the thermal reaction conditions, such as pressure, temperature, vapor residence time. Such feedstock favors the production of limonene monomers.

The base ELT oil comprises mainly of a mixture of hydrocarbons with a wide range of boiling points. The majority of these compounds form part of the family of the alkanes, olefins, naphthenes (cycloalkanes) and aromatics.

More particularly, the base ELT oil can be characterized as comprising at least 20 wt. % C₄-C₁₂ olefinic monomers comprising at least styrenics, limonenes and indenes, among others. Certain species containing heteroatoms may also be present. Upon analysis of samples of the base ELT oil, it is discovered that such oil is further characterized by over thirty (30) components at levels approximating 1% or in trace amounts.

It is discovered that the base ELT oil may be further refined to shift the distribution of components. It has been discovered that treating the base ELT oil by distillation can yield an ELT oil sample that contains greater limonene content. It is expected that additional distillations can be performed to reach a desired purity.

The present invention relates to a method of forming a resin using the ELT oil. Such method comprises the steps below:

### Polymerization

In the practice of this invention, the untreated resinous material is prepared by polymerizing a hydrocarbon mixture comprising from 50 to 95 weight percent of ELT oil and from 5 to 50 ppm of a methanol initiator in the presence of an anhydrous metal halide catalyst, which can act as a co-initiator. In the preferred embodiment, the mixture to be polymerized comprises from 65 to 95 weight percent of ELT oil and from 5 to 35 weight percent of inert solvent. In one embodiment, from about 0.5 weight percent to about 5 weight percent, and more preferably from about 1 wt % to about 3 wt % anhydrous metal halide catalyst can be employed.

In practice, various anhydrous metallic or boron halide catalysts can be used to prepare the untreated resinous material. Representative examples of such catalysts are fluorides, chlorides bromides, and iodides of aluminum, tin, and boron. Such catalysts include, for example, aluminum chloride, stannic chloride, and boron trifluoride. Aluminum chloride and stannic chloride are preferred.

In carrying out the polymerization reaction, the hydrocarbon mixture is brought into contact with the anhydrous metal halide catalyst. Generally, the catalyst is used in particulate form or supported on light granular, and preferably porous particles. Generally, a particle size in the range of from 5 to 200 mesh size is used although larger or smaller particles can be used. The amount of catalyst used is not critical although sufficient catalyst must be used to cause a polymerization reaction to occur. In the contemplated embodiment, sufficient catalyst may approximate from between about 200 to about 500 ppm methanol.

The catalyst may be added to the hydrocarbon mixture, or the hydrocarbon mixture may be added to the catalyst. If desired, the catalyst and mixture of hydrocarbons can be added simultaneously or intermittently to a reactor. The reaction can be conducted continuously or by batch process techniques generally known to those skilled in the art.

The polymerization reaction is conducted in an organic solvent. Various solvents which are inert in that they do not enter the polymerization reaction may be used. Representative examples of inert solvents are aliphatic hydrocarbons such as pentane, hexane, and heptane, aromatic hydrocarbons such as toluene and benzene, and unreacted residual hydrocarbons from the reaction. Particularly preferred polar solvents are selected from the group consisting of benzene, toluene, xylene, chlorobenzene and methylene chloride.

Non-polar organic solvents, while not preferred, may also be used in conjunction with a polar solvent. The non-polar solvents may be selected from the group consisting of hexane, pentane, cyclohexane, napthas and olefins which are relatively inert under the conditions involved in the reaction, such as cyclopentene.

The total volume ratio of solvent to ELT oil in the reaction mixture may range from about 1:2 to about 1:6.

It is preferred to charge the reaction vessel with the solvent and catalysts and then add the ELT oil to the reaction vessel over time while stirring the reaction mixture. However, the ELT oil and catalyst may be added to the reaction vessel essentially simultaneously, particularly when conducting a continuous polymerization reaction.

A wide range of temperatures can be used for the polymerization reaction. The polymerization can be carried out at temperatures in the range of from 20° C. to 1000° C., although usually the reaction is carried out at a temperature in the range of from 0° C. to 500° C. The polymerization reaction pressure is not critical and may be atmospheric or above or below atmospheric pressure.

Generally, a satisfactory polymerization can be conducted when the reaction is carried out at about autogenous pressure developed by the reactor under the operating conditions used. The time of the reaction is not generally critical and reaction times can vary from a few seconds to 12 hours or more.

### Washing

After the polymerization reaction is substantially complete, the reaction product mixture is quenched to a temperature ranging from about 15° C. to about 40° C. with water and heated to a temperature ranging from about 50° C. to about 90° C.

### Vacuum Distillation and Nitrogen Sparging

After washing, the organic phase is distilled and sparged according to the process disclosed in U.S. Pat. No. 6,121,392 to Arizona Chem Co., the contents of which are incorporated herein in their entirety. In the contemplated embodiment, the separated organic phase may be washed with an alcohol and water blend at an elevated temperature to remove traces of catalyst and other impurities. The organic phase is distilled from the product under atmospheric pressure at a temperature of 240° C. A crude resin is then nitrogen sparged at 240° C. to remove the dimers and to yield the lowest molecular weight resin (hereinafter “ELT resin”), as determined by the ring and ball method of ASTM E-28-58T. This is to separate the aqueous phase from the organic phase. In alternative embodiments it can be performed by well-known phase separation techniques such as decantation, centrifugation, extraction, drying and the like.

In one embodiment, the ELT resin is a hydrocarbon resin. The hydrocarbon resin may be, for example, an aromatic and/or a nonaromatic based resin. Differences in resins are largely due to the olefins contained in the ELT-based feedstock from which the resin is derived.

In one embodiment, the ELT resin is a terpene resin from the group dipentene (D,L-limonene). The terpene resin may be comprised of, for example, polymers of limonene and has a softening point in a range from about 60° C. to 170° C.

In another embodiment, the terpene can be used with other petroleum-based monomers, like styrene, to form a resinous product. Any process known to one of ordinary skill in the art can be employed. More particularly, the terepene or ELT resin can be copolymerized with other hydrocarbon cuts like C5 (olefins and diolefins containing an average of five carbon atoms), C9 (olefins and diolefins containing an average of nine carbon atoms), alphamethylstyrene (AMS), or mixtures thereof. In other embodiments, the terpene can be copolymerized with a phenolic monomer to form a terpene-phenol resin. An exemplary terpene-phenol resin may be a copolymer of phenolic monomer with limonene. Polymeric resinous materials containing units derived from limonene and more than one of DCPD, indene, teretiary-butyl styrene, indene AMS, vinyl toluene, dimethyl-dicyclopentadiene are contemplated as well. The resin compound can be liquid or solid.

In the contemplated embodiment, the resin can comprise a traction resin or plasticizing resin, or tackifying resin. In one embodiment, the resin may be partially or fully hydrogenated. In one embodiment, the resin may undergo further hydrogenation to obtain a desired degree of saturation according to processes known to one of ordinary skill in the art.

In summary, the ELT fraction can be co-polymerized to synthesize a possible resin within a desired grade, cut or blend. The present invention relates to a resin consisting essentially of the reaction product of the polymerization reaction between monomers from ELT oil and has a glass transition temperature (Tg) ranging from about −30° C. to about 140° C., a softening point from about 10° C. to about 170° C. and a molecular weight Mw between 100 and 5000 Dalton (Da).

The resins of this invention are particularly useful as modifiers for natural rubber and various synthetic rubber compositions. In accordance with the invention, various articles of manufacture, such as, for example tires and industrial rubber products, may be prepared using such rubber compositions. Upon vulcanization, such a rubber composition may be incorporated into a pneumatic or non-pneumatic tire, belt, hose, air spring, shoe product or motor mount. In the case of a tire, the rubber composition may be incorporated in a variety of rubber tire components, such as, for example, a tread (including tread cap and/or tread base), sidewall, apex, chafer, sidewall, insert, wirecoat and/or innerliner. In one embodiment, the compound is a tread. The current ELT oil-derived resin is contemplated for use in silica tread compounds as a traction resin delivering a balanced performance. In one embodiment, the disclosed resin is contemplated for use in high performance tire compounds comprising one or both a high silica and a high resin loading. In yet further embodiments, the ELT hydrocarbon-based resin disclosed herein can be used in adhesives.

A tire of the present invention may be a race tire, passenger tire, aircraft tire, agricultural tire, earthmover, off-the-road tire, truck tire, and the like. The tire may also be radial or bias.

The resin can be used as a partial or full replacement of regular plasticizers and blends, which are typically used in compounds for tire & technical goods compounds, like traction, tackifier and processing resin and can be used in combinations with other resins, such as hydrocarbon or biobased resins, oils, processing aids, and blends thereof. In one embodiment, the ELT hydrocarbon-based resin can be used as an extender-by replacing the extender oil-in synthetic polymers, such as styrene butadiene (SSBR) and polybutadiene (BR).

The following examples further illustrate the invention and are not intended to be limiting. In these examples, parts and percentages are by gram unless otherwise indicated.

### EXAMPLES

The reactants, reaction conditions and product characteristics (sample 1) are given in the Table II.

### Example 1: Limonene Resin

To a neck 3-liter flask equipped with a mechanical stirrer, nitrogen and thermocouple was added 210 mL toluene, 175 ml isooctane and 11.8 grams of aluminum chloride. The reaction mixture was cooled in a water bath to 14° C. Then 50 mL of limonene and 0.12 grams of methanol initiator were added to the mixture The temperature was increased to 29° C. and the mixture turned an orange amber color. The mixture was allowed to cool to 20° C. after which additional portions of limonene were added. The process was repeated until a total of 500 mL of limonene added. An additional 2.4 grams of aluminum chloride was added, and the mixture was allowed to react four hours with continuous stirring.

The reaction was quenched with 500 mL of 30% isopropanol water solution. The water layer was siphoned off and the mixture washed with two additional portions of 500 mL of aqueous isopropanol. The hydrocarbons were removed by vacuum distillation (roto-evaporator), slowly incrementally until the final temperature was 90° C. and vacuum 10-15 torr. Lastly, the resin was refined by high temperature nitrogen sparging as described in U.S. Pat. No. 6,121,392 to Arizona Chemical Company, the contents of which are incorporated by reference herein in their entirety. The resulting resin was a hard off-white solid characterized by a 133° C. softening point determined by the ring and ball method of ASTM E-28-58T and at 87.4° C. glass transition temperature determined by DSC differential scanning calorimetry at 10K/min. ramp rate.

### Example 2: Resin From 8% Limonene ELT Oil

To a neck 3-liter flask equipped with a mechanical stirrer, nitrogen and thermocouple was added 210 mL toluene, 175 ml isooctane and 11.8 grams of aluminum chloride. The reaction mixture was cooled in a water bath to 14° C. Then 50 mL of ELT oil and 0.12 grams of methanol initiator were added to the mixture The temperature was increased to 29° C. and the mixture turned an orange amber color. The mixture was allowed to cool to 20° C. after which additional portions of ELT oil were added. The process was repeated until a total of 500 mL of ELT oil added. An additional 2.4 grams of aluminum chloride was added, and the mixture was allowed to react four hours with continuous stirring.

The reaction was quenched with 500 mL of 30% isopropanol water solution. The water layer was siphoned off and the mixture washed with two additional portions of 500 mL of aqueous isopropanol. The hydrocarbons were removed by vacuum distillation (roto-evaporator), slowly incrementally until the final temperature was 90° C. and vacuum 10-15 torr. Lastly, the resin was refined by high temperature nitrogen sparging as described in U.S. Pat. No. 6,121,392 to Arizona Chemical Company, the contents of which are incorporated by reference herein in their entirety. The resulting resin was a hard off-white solid characterized by a 75.5° C. softening point determined by the ring and ball method of ASTM E-28-58T and a 19.9° C. glass transition temperature determined by DSC differential scanning calorimetry at 10K/min. ramp rate.

### Example 3: Resin From 15% Limonene ELT Oil

The sample was prepared following the method described for Example 2 except the ELT oil was twice distilled with 15% limonene content.

The resulting resin was a semi-hard amber solid characterized by a 66.9° C. softening point determined by the ring and ball method of ASTM E-28-58T and a 14.1° C. glass transition temperature determined by DSC (differential scanning calorimetry) at 10K/min ramp rate.

TABLE II

| | Commercial | Comparative | Inventive | Inventive |
|---|---|---|---|---|
| | Resin^{A} | Example 1^{B} | Example 2^{C} | Example 3^{D} |
| Limonene content in ELT oil | 100% | 100% | 8% | 15% |
| Glass Transition Temperature¹, ° C. | 73 | 87 | 20 | 14 |
| Ring and Ball Softening Pt², ° C. | 122 | 133 | 75 | 67 |
| Molecular Weight Mw, g/mole³ | 1100 | 1070 | 550 | 520 |

^{A}Polyterpene resin commercially available under the tradename DERCOLYTE L 120
^{B}Resin synthesized using Limonene, 88% monomer
^{C}Resin synthesized using distilled ELT oil resin; limonene + styrene + indene monomers
^{D}Resin synthesized using fractioned ELT oil resin; limonene + styrene monomers
¹ASTM D3418-75
²ASTM E28-58T
³ASTM D6579-11

Table III characterizes an exemplary resin material in accordance with aspects of the exemplary embodiment.

TABLE III

| | EMBODIMENT 1 | EMBODIMENT 2 |
|---|---|---|
| Glass Transition Temperature¹, ° C. | −30-140 | 55-85 |
| Ring and Ball Softening Pt², ° C. | 10-170 | 100-130 |
| Molecular Weight Mn, g/mole | 100-5000 | 500-1000 |

¹ASTM D3418-75
²ASTM E28-58T
³ ASTM D6579-11

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A hydrocarbon resin comprising a reaction product of the polymerization reaction of end of life tires (ELT) oil monomers and having a Tg ranging from about −30° C. to about 140° C., a softening point from about 10° C. to about 170° C. and a molecular weight Mw between 100 and 5000 Da.

2. The resin of claim 1 wherein the ELT oil is derived from a thermal depolymerization of tires and/or other rubber articles.

3. The resin of claim 2, wherein the ELT oil is from the thermal depolymerization of substantially whole tires.

4. The resin of claim 1, wherein ELT oil is from the thermal depolymerization of cured and/or uncured rubber production plant waste.

5. The resin of claim 1, wherein the hydrocarbon resin is formed solely from the ELT oil monomers.

6. The resin of claim 1, wherein the hydrocarbon resin is formed from ELT oil monomers copolymerized with other hydrocarbon cuts.

7. The resin of claim 6, wherein the hydrocarbon cuts are selected from a group comprising:
like C5, C9, AMS, DCPD, rosin, phenol, epoxy, sole or with blend thereof.

8. The resin of claim 1, wherein the resin is hydrogenized.

9. The resin of claim 1, wherein the resin is liquid.

10. The resin of claim 1, wherein the resin is solid.

11. The resin of claim 1, wherein the resin is incorporated into a rubber article.

12. The resin of claim 11, wherein the rubber article is a tire component.

13. The resin of claim 1, wherein the resin is incorporated into an adhesive formulation.

14. A tire having a tread and or carcass compound comprised of:
at least one rubber selected from the group consisting of natural rubber, rubbers derived from a diene monomer, and mixtures thereof; and
an ELT oil hydrocarbon-based resin of claim 1.

15. The tire of claim 11, wherein the ELT oil is from thermal depolymerization of end-of-life tires (ELTs).

16. A method for forming a resin from ELT oil, the method comprising the steps of:
obtaining an ELT oil derived from thermal depolymerization of end-of-life tires (ELTS); and
polymerizing the ELT oil to produce an ELT hydrocarbon-based resin.

17. The method of claim 16 further comprising:
optionally refining the ELT oil to a desired hydrocarbon composition.

18. The method of claim 16 wherein the polymerizing comprises:
polymerizing monomers of the ELT oil to produce the ELT hydrocarbon-based resin.

19. The method of claim 16 wherein the polymerizing comprises:
copolymerizing monomers of the ELT oil with other hydrocarbon cuts to produce the ELT hydrocarbon-based resin.
